(19) United States
(12) Patent Application Publication
(10) Pub. No.: US 2024/0241662 A1
(43) Pub. Date: Jul. 18, 2024

(54) INFORMATION PROCESSING APPARATUS AND CONTROL METHOD THEREFOR

(71) Applicant: CANON KABUSHIKI KAISHA, Tokyo (JP)

(72) Inventor: NAOTO SASAHARA, Ibaraki (JP)

(21) Appl. No.: 18/408,999

(22) Filed: Jan. 10, 2024

(30) Foreign Application Priority Data
Jan. 18, 2023 (JP) 2023-005655

(51) Int. Cl. G06F 3/06

(52) U.S. Cl. CPC G06F 3/0655; G06F 3/061; G06F 3/0673; G06F 2213/0042

(57) ABSTRACT

An information processing apparatus performs control in a first mode in which respective drivers to be associated with a first type storage device and a second type storage device are each set to be a storage driver if setting values do not satisfy a predetermined condition, and performs control in a second mode in which the driver to be associated with the second type storage device is set to be the storage driver and the driver to be associated with the first type storage device is not set to be the storage driver if the setting values satisfy the predetermined condition.

### BACKGROUND

### Field

The present disclosure relates to an information processing apparatus and a control method for the information processing apparatus.

### Description of the Related Art

In a host computer with a Universal Serial Bus (USB) interface (I/F) mounted thereon, a USB storage, a USB card reader, a USB keyboard, and the like can be connected to the host computer to use them as one device. This is because a USB host controller is provided in the host computer. Any USB device can be used by a user, but there may be a setting for a USB storage or the like to be prohibit the use of the USB storage for better security.

Japanese Patent Application Laid-open No. 2010-191717 discusses a technique of determining whether to register a device driver for controlling a predetermined USB device with a USB core driver, based on a setting value of an image forming apparatus.

### SUMMARY

According to an aspect of the present disclosure, an information processing apparatus includes a first controller configured to detect at least a first type storage device that is universal serial bus (USB)-connected to the information processing apparatus externally and is connectable by a user, and a second type storage device that is USB-connected to the information processing apparatus inside the information processing apparatus, and a second controller configured to associate a storage device detected by the first controller with a driver, wherein in a case where setting values relating to storage devices do not satisfy a predetermined condition, the second controller performs control in a first mode in which respective drivers to be associated with the first type storage device and the second type storage device are each set to be a storage driver, and wherein in a case where the setting values satisfy the predetermined condition, the second controller performs control in a second mode in which the driver to be associated with the second type storage device is set to be the storage driver and the driver to be associated with the first type storage device is not set to be the storage driver.

Further features of the present disclosure will become apparent from the following description of exemplary embodiments with reference to the attached drawings.

### BRIEF DESCRIPTION OF THE DRAWINGS

FIG. 1 is a block diagram illustrating a basic hardware configuration of an image forming apparatus.

FIG. 2 is a block diagram illustrating a hardware configuration relating to a Universal Serial Bus (USB) interface (I/F) of the image forming apparatus.

FIG. 3 is a diagram illustrating a screen for making settings relating to use of a USB device.

FIG. 4 is a block diagram illustrating a software configuration of the image forming apparatus.

FIG. 5 is a flowchart illustrating a flow of processing performed when the forming apparatus starts up.

FIG. 6 is a flowchart illustrating a flow of processing performed when a USB storage is connected to the image forming apparatus.

FIG. 7 is a flowchart illustrating a flow of probe processing of a device driver.

FIG. 8 is a diagram illustrating a screen displayed when a user performs an operation to change a USB setting.

FIG. 9 is a flowchart illustrating a flow of processing performed when the USB setting is changed.

### DESCRIPTION OF THE EMBODIMENTS

Exemplary embodiments of the present disclosure will be described in detail with reference to the attached drawings. Note that the following exemplary embodiments are not intended to limit the scope of the claimed disclosure, and not all the combinations of the features described in the following exemplary embodiments are necessarily essential. In the exemplary embodiments, descriptions will be given of an image forming apparatus as an example of an information processing apparatus. However, it is not limited thereto.

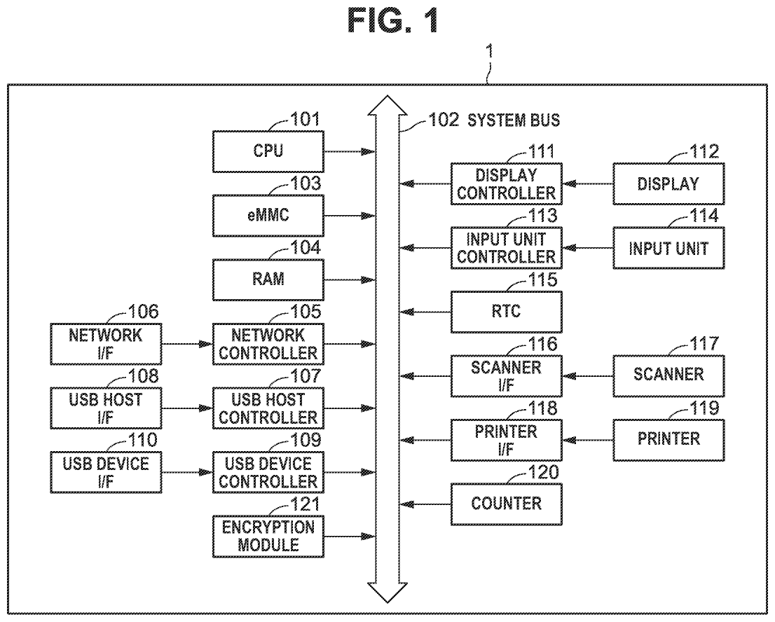

FIG. 1 is a block diagram illustrating a hardware configuration of an image forming apparatus 1 according to a first exemplary embodiment. With reference to FIG. 1, a configuration of the image forming apparatus 1 will be described.

The image forming apparatus 1 includes a central processing unit (CPU) 101, a system bus 102, and an embedded Multimedia Card (eMMC) 103. The CPU 101 executes software for operating the image forming apparatus 1. The system bus 102 is used by the CPU 101 to access other units, and is a path for other units to access each other. The eMMC 103 stores software for the image forming apparatus 1, database for the image forming apparatus 1 to operate, and a temporary storage file.

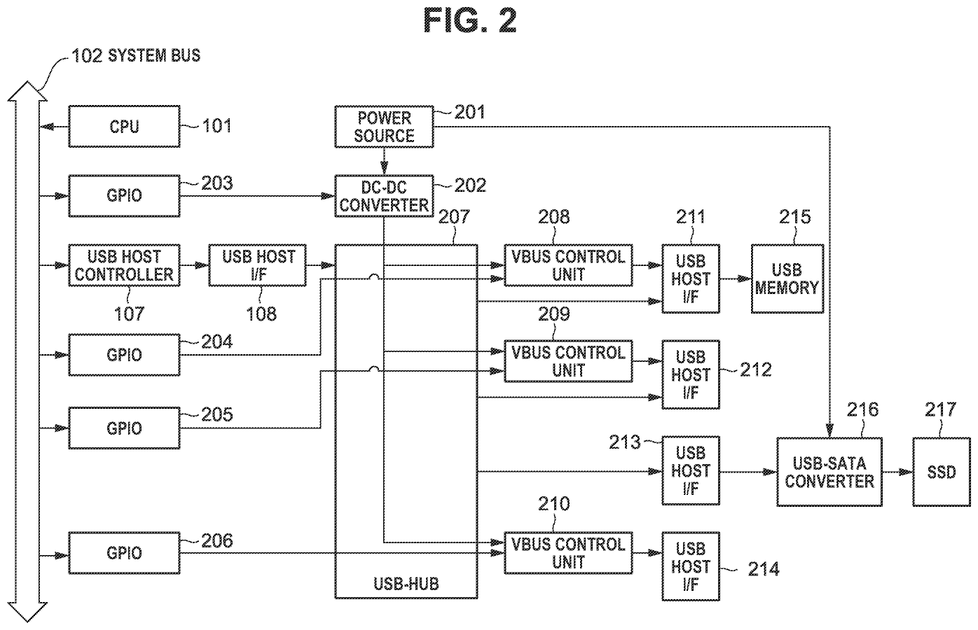

In FIG. 1, the eMMC 103 is illustrated, but a large-capacity nonvolatile memory such as a hard disk device (HDD) and a solid state device (SSD) may be used. A random access memory (RAM) 104 is a storage area in which a program for the image forming apparatus 1 is loaded, and valuables used when the program is operated and data transferred from each unit using direct memory access (DMA) are stored. A network controller 105 and a network interface (I/F) 106 are used for communication between the image forming apparatus 1 and other devices on a network. A Universal Serial Bus (USB) host controller 107 and a USB host I/F 108 can detect USB devices that are USB-connected to the image forming apparatus 1 and can control communications between the detected USB devices and the image forming apparatus 1. In FIG. 1, only one USB host I/F 108 is illustrated, but the image forming apparatus 1 actually includes USB host I/Fs 211, 212, 213, and 214 (see FIG. 2) via a USB-HUB 207. Each of the USB host I/Fs 211, 212, 213, and 214 is connected with a USB device via a USB cable.

Depending on a type of the USB device, the USB device is connected directly to the image forming apparatus 1 without using a USB cable. For example, a USB device controller 109 and a USB device I/F 110 are connected to an apparatus having a USB host function, such as a personal computer (PC) and are used to receive data such as print data and scan data.

A display 112 displays an operation status of the image forming apparatus 1 so that a user can visually recognize the operation status of the image forming apparatus 1. A display controller 111 performs display control of the display 112. An input unit 114 receives instructions issued by a user to the image forming apparatus 1. An input unit controller 113 controls the input unit 114. More specifically, the input unit 114 is an input system such as a keyboard, a mouse, a numeric keypad, a cursor key, a touch panel, and an operation unit keyboard.

In a case where the input unit 114 is a touch panel, the input unit 114 is physically attached onto a surface of the display 112.

A real time clock (RTC) 115 has a clock function, an alarm function, a timer function, and the like for the image forming apparatus 1. A scanner 117 is connected to the image forming apparatus 1 via the system bus 102 and a scanner I/F 116. Further, a printer 119 is connected to the image forming apparatus 1 via the system bus 102 and a printer I/F 118. A counter 120 is used to record the number of sheets printed using a printer function, a copy function, or the like. An encryption module 121 is used to encrypt data to be stored in a storage.

FIG. 2 is a block diagram illustrating a configuration of the USB host I/Fs mounted on the image forming apparatus 1, and a state where USB devices are connected to the USB host I/Fs. The USB host controller 107 operates based on the instruction of the CPU 101, and communicates with the USB devices connected to the respective USB host I/Fs 211, 212, 213, and 214. In FIG. 2, the USB-HUB 207 is connected to the USB host controller 107 via the USB host I/F 108, and the USB host I/Fs 211, 212, 213, and 214 are provided via the USB-HUB 207. However, each of the USB host I/Fs 211, 212, 213, and 214 may be directly connected to the USB host controller 107.

The USB-HUB 207 has a function of relaying communications between the USB host controller 107 and the USB devices connected to the USB host I/Fs 211, 212, 213, and 214. The USB-HUB 207 enables a plurality of the USB devices to connect to the USB host controller 107.

When a USB device is connected to any one of the USB host I/Fs 211, 212, 213, and 214, the CPU 101 acquires via the USB host controller 107 device information of the USB device connected to the one of the USB host I/Fs 211, 212, 213, and 214. The device information to be acquired includes, for example, a Vendor identifier (VID), a Product ID (PID), and a Class ID (CID), and the USB device is controlled by associating a proper device driver with the USB device based on the information. The VID is information to identify a manufacturer of the USB device. The PID is information to identify a product. The CID is information to identify a type of the USB device. The information to identify the type of the USB device is, for example, “Human Interface Device (HID)” if the USB device is an input device, and “Storage Class” if the USB device is a storage device. In the present exemplary embodiment, the USB devices are USB devices when seen from the USB host I/F 213, and are a USB-Serial Advanced Technology Attachment (USB-SATA) converter 216 and a solid state drive (SSD) 217.

Examples of the device drivers used by the image forming apparatus 1 include a HID driver, a storage driver, a Wireless Local Area Network (WLAN) driver, a general-purpose driver, a HUB driver, and an Ethernet driver. Power supplied to a VBUS of each of the USB host I/Fs 211, 212, and 214 is generated from a power source 201 via a Direct-Current to Direct-Current (DC-DC) converter 202.

The power generated by the DC-DC converter 202 is input to VBUS control units 208, 209, and 210. The power generated by the DC-DC converter 202 is subjected to logical ANDs using outputs of General Purpose Input/Outputs (GPIOs) 204, 205 and 206 and AND circuits and then input to the USB host I/Fs 211, 212, and 214.

With this configuration, the CPU 101 can control the GPIOs 204, 205, and 206 to switch ON/OFF the VBUS power to be supplied to the USB host I/Fs 211, 212, and 214. Further, the CPU 101 can switch the operation mode of the DC-DC converter 202 by controlling a GPIO 203.

A USB memory 215 is an example of a USB storage that can be externally attached to the image forming apparatus 1 by a user. The USB memory 215 is recognized by the CPU 101 when externally attached to the image forming apparatus 1. For example, when the USB memory 215 storing a Portable Document Format (PDF) file is externally attached to the image forming apparatus 1, the image forming apparatus 1 can print the PDF file. Further, the image forming apparatus 1 may store data generated by reading a document in the USB memory 215.

The SSD 217 is used as a print data storage area, for example, in a function called reservation printing. The reservation printing function is a function of temporarily storing print data received via the network I/F 106, and printing the print data when the image forming apparatus 1 receives a print execution instruction from the user later at any timing. The print data used for functions other than the reservation printing function is assumed to be stored in the eMMC 103, but may be stored in the SSD 217.

The USB host I/F 213 is configured to connect a USB storage (SSD 217 in the present exemplary embodiment) used by the function called reservation printing, and does not have a VBUS control unit, different from the other USB host I/Fs 211, 212, and 214. To the USB host I/F 213, the USB-SATA converter 216 is connected, and subsequently the SSD 217 is connected. The USB-SATA converter 216 has a function of converting USB protocol data into SATA protocol data. Power is directly supplied to the USB-SATA converter 216 from the power source 201. By connecting the USB-SATA converter 216, the SSD 217 can be treated as a USB storage. In addition, in the present exemplary embodiment, the SSD 217 is described as an example, but an HDD may be used instead. Further, the SSD 217 is provided inside the image forming apparatus 1.

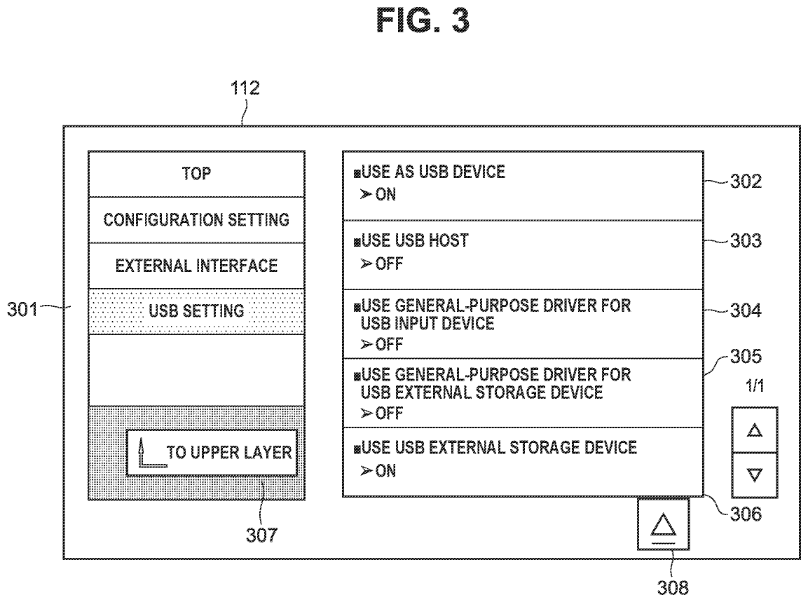

FIG. 3 is an example of a screen displayed on the display 112 of the image forming apparatus 1. A screen 301 is a screen used for performing a USB setting. A setting 302 for using a device as a USB device is a setting to set whether to enable the USB device I/F 110.

A setting 303 for using a USB host is a setting to set whether to enable the USB host I/Fs 211, 212, 213, and 214. A setting 304 for using a general-purpose driver for the USB input device is a setting to set whether to use a general-purpose driver for controlling the USB input device such as a keyboard and a mouse. A setting 305 for using a general-purpose driver for a USB external storage device is a setting to set whether to use a general-purpose driver for controlling a USB external storage device. In a case where the setting 305 is OFF, the storage driver is set for the USB external storage device.

The general-purpose driver will be described below. A setting 306 for using the USB external storage device is a setting to set whether to use a USB storage when the USB storage is connected to any of the USB host I/Fs 211, 212, 213, and 214. The setting 303, the setting 305, and the setting 306 are settings relating to external storage devices.

An object 307 is a button to return to an upper layer of the setting screen. An object 308 is a disconnection button for the USB memory 215 which is displayed when the USB memory 215 is connected. A user can instruct the image forming apparatus 1 to disconnect the USB memory 215 by pressing the disconnection button, and the user can remove the USB memory 215 after the CPU 101 performs disconnection processing. The USB-SATA converter 216 and the SSD 217 are devices connected inside the image forming apparatus 1. Thus, the USB-SATA converter 216 and the SSD 217 are not configured to be removed, so that a button for the SSD 217 corresponding to the object 308 is not displayed.

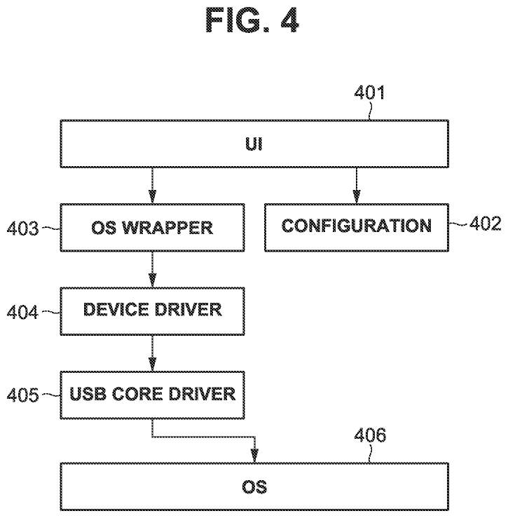

FIG. 4 is a block diagram illustrating a software configuration of the image forming apparatus 1 according to the present exemplary embodiment. A user interface (UI) 401 is software for displaying a screen on the display 112, and controlling input operation from a user.

An operating system (OS) Wrapper 403 is software for abstracting an OS 406 and a Device Driver 404. The OS Wrapper 403 has a function of processing for registering with the Device Driver 404 to a USB Core Driver 405, and of detecting the connection/disconnection of a device and issuing a notification of a result of detection.

The Device Driver 404 is software for controlling reading and writing data from and into a device. There are different drivers for respective types of USB devices, including a storage driver and a general-purpose driver. The storage driver is a driver for controlling the USB device having a data storage area such as the USB memory 215 and the SSD 217, and enables data to be read from and written into the storage area. The general-purpose driver can control all kinds of USB devices, but can only perform basic data reading and writing. Further, the Device Driver 404 has a function of communicating with the USB device using the function of the USB Core Driver 405, after being probed (associated) with the corresponding device.

A configuration 402 is software for managing setting values, and manages the setting values illustrated in FIG. 3. The USB Core Driver 405 is a driver having a common process to communicate with the USB devices. The OS 406 is an operating system, and has a basic function of controlling the hardware and operating other software.

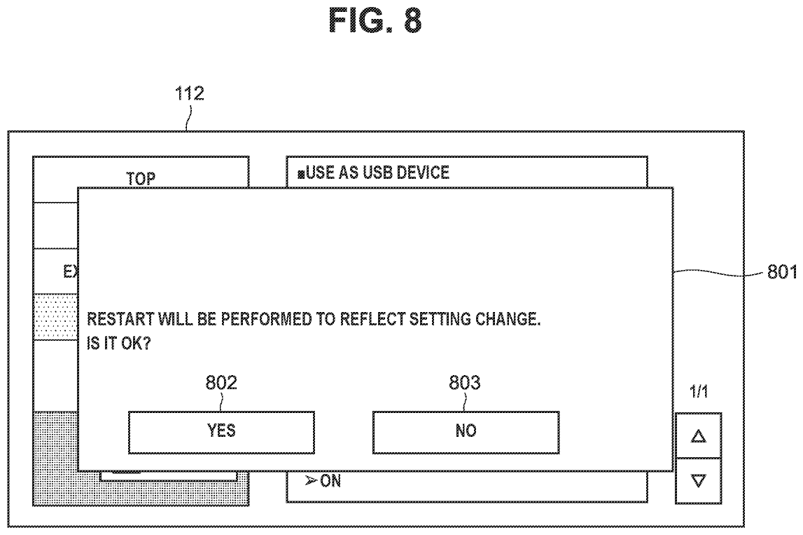

FIG. 8 is a screen displayed when a user changes the USB setting by performing operation on the screen 301. A screen 801 for prompting a restart of the image forming apparatus 1 when the USB setting is changed is displayed, and a “YES” button 802 and a “NO” button 803 are displayed thereon.

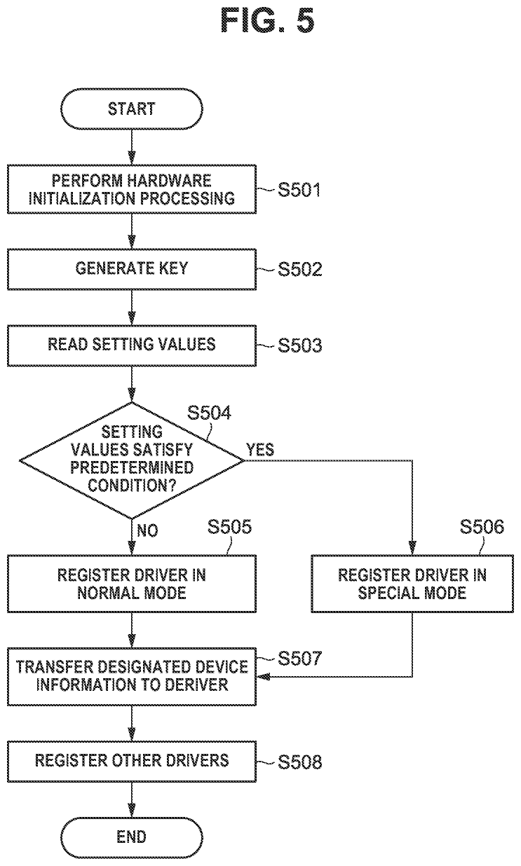

FIGS. 5, 6, 7, and 9 are flowcharts illustrating main processing flows according to the present exemplary embodiment.

With reference to FIGS. 5, 6, 7, and 9, the present exemplary embodiment will be described. The processing described below is executed by the CPU 101 unless otherwise noted.

FIG. 5 is a flowchart illustrating processing according to the present exemplary embodiment which is performed when the image forming apparatus 1 starts up.

In step S501, when a user powers on the image forming apparatus 1, the CPU 101 performs initialization processing of the hardware. In step S502, the CPU 101 generates a key for encrypting a storage. The generated key is stored in the encryption module 121.

In step S503, the CPU 101 reads setting values managed by the configuration 402. In step S504, the CPU 101 checks the setting values of the setting 303, the setting 305, and the setting 306.

In step S504, in a case where the setting values satisfy a predetermined condition (YES in step S504), the processing proceeds to step S506. To satisfy the predetermined condition, for example, at least one of the setting 303 and the setting 306 is OFF, or all of the setting 303, the setting 305, and the setting 306 are ON.

In step S506, the CPU 101 registers the storage driver with the USB Core Driver 405 in a special mode. In the special mode, the CPU 101 probes only the device designated by the Storage class, the VID and the PID.

In the present exemplary embodiment, the term “probe” used herein refers to a state that a device and a device driver are associated with each other by the OS, so that the CPU 101 can control the associated device. The CPU 101 sequentially performs probe processing on the device drivers registered with the USB Core Driver 405, and the device driver that has succeeded first in the probe is used.

Examples of the probe of a device in the special mode are as follows. For example, in a case where the condition in which all the setting 303, the setting 305, and the setting 306 are ON is satisfied, the SSD 217 is probed with the storage driver, and the USB memory 215 is probed with the general-purpose driver. On the other hand, in a case where the condition in which at least one of the setting 303 and the setting 306 is OFF is satisfied, the SSD 217 is probed with the storage driver, and the USB memory 215 is not probed with any driver. More specifically, the special mode functions as a mode to eliminate the SSD 217 from the “USB external storage device” in the setting 305 and the setting 306.

In a case where the setting values do not satisfy the predetermined condition (NO in step S504), the processing proceeds to step S505. In step S505, the CPU 101 registers the driver with the USB Core Driver 405 in a normal mode, in which the Storage class device is probed. The case where the setting values do not satisfy the predetermined condition is, for example, a case where the setting 303 and the setting 306 are ON, and the setting 305 is OFF. In the normal mode, the SSD 217 and the USB memory 215 are probed with the storage driver.

As described above, since the SSD 217 is probed with the storage driver both in steps S505 and S506, the SSD 217 becomes readable and writable regardless of the setting values of the setting 303, the setting 305, and the setting 306.

Next, in step S507, the CPU 101 transfers information about the VID and the PID of the designated device to the storage driver. As the information about the designated device, the information stored in the eMMC 103 in advance is used.

In step S508, when the registration of the storage driver is completed, the CPU 101 registers the remaining HID driver, WLAN driver, general-purpose driver, HUB driver, and Ethernet driver with the USB Core Driver 405.

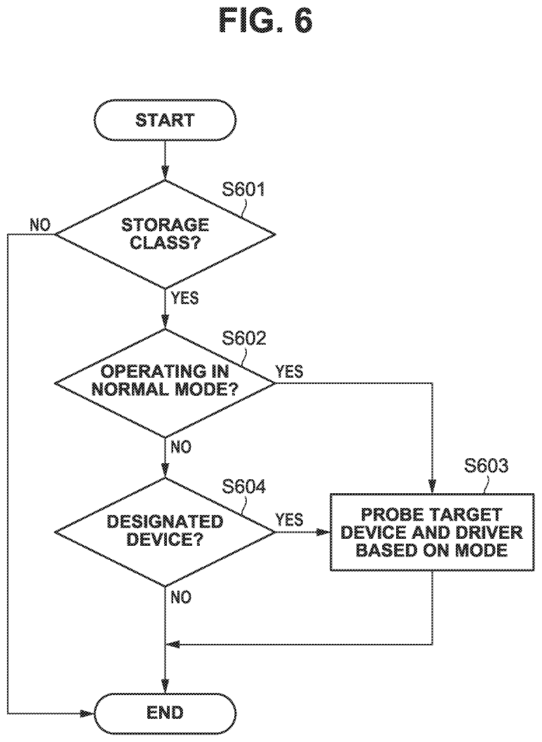

FIG. 6 is a flowchart illustrating a flow of processing performed when the probe processing is performed on a target device in the storage driver. In step S601, the CPU 101 determines whether a target device belongs to the Storage class.

In step S601, in a case where the target device does not belong to the Storage class (NO in step S601), the processing ends. In step S601, in a case where the target device belongs to the Storage class (YES in step S601), the processing proceeds to step S602. In step S602, the CPU 101 determines whether the storage driver is operating in the normal mode.

In a case where the storage driver is operating in the normal mode (YES in step S602), the processing proceeds to step S603. In step S603, the CPU 101 probes the target device and the driver.

In step S602, in a case where the storage driver is not operating in the normal mode (NO in step S602), for example, in a case where the storage driver is operating in the special mode, the processing proceeds to step S604. In step S604, the CPU 101 checks whether the target device is a designated device. More specifically, the CPU 101 checks whether the VID and PID of the target device match the VID and PID of the designated device.

In step S604, in a case where the target device is the designated device (YES in step S604), the processing proceeds to step S603. In step S604, in a case where the target device is not the designated device (NO in step S604), the processing in the flowchart ends.

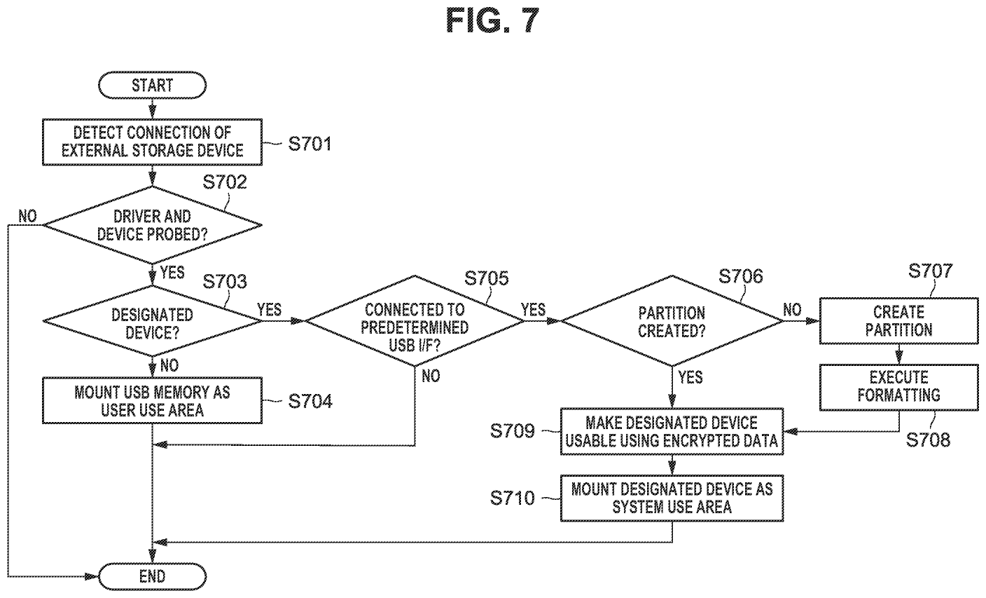

FIG. 7 is a flowchart illustrating a flow of connection processing of the USB storage.

In step S701, the CPU 101 detects connection of the USB storage. After completing the processing in step S701, the processing proceeds to step S702.

In step S702, the CPU 101 determines whether the storage driver and the device are probed. In step S702, the storage driver and the device are not Probed (NO in step S702), the processing ends. In step S702, the storage driver and the device are probed

(YES in step S702), the processing proceeds to step S703.

In step S703, the CPU 101 determines whether the USB storage detected in step S701 is the designated device. For example, the designated device is the SSD 217. In a case where the USB storage is not the designated device (NO in step S703), the processing proceeds to step S704.

In step S704, the CPU 101 determines that the USB storage is the USB memory 215 connected to the image forming apparatus 1 by a user, and the CPU 101 mounts the USB memory 215 as a user use area. the term “mount” used herein refers to processing of connecting the USB storage so that an application can read and write a file from and into the USB storage.

In step S703, in a case where the USB storage is the designated device (YES in step S703), the processing proceeds to step S705. In step S705, the CPU 101 determines whether the designated device is connected to a predetermined USB I/F. In step S705, in a case where the designated device is not connected to the predetermined USB I/F (NO in step S705), the processing in the flowchart ends. In step S705, in a case where the designated device is connected to the predetermined USB I/F (YES in step S705), the processing proceeds to step S706.

In step S706, the CPU 101 determines whether partitions are created in the designated device. In step S706, in a case where partitions are created (YES in step S706), the processing proceeds to step S709. In step S706, in a case where partitions are not created (NO in step S706), the processing proceeds to step S707. In step S707, the CPU 101 creates partitions. Then, in step S708, the CPU 101 executes formatting of the designated device. After completing the formatting, the processing proceeds to step S709.

In step S709, the CPU 101 makes the designated device usable using encrypted data. In this way, the data to be read from and written into the designated device can be encrypted using an encryption key stored in the encryption module 121. In step S710, the CPU 101 mounts the designated device as a system use area after completing the processing of these steps.

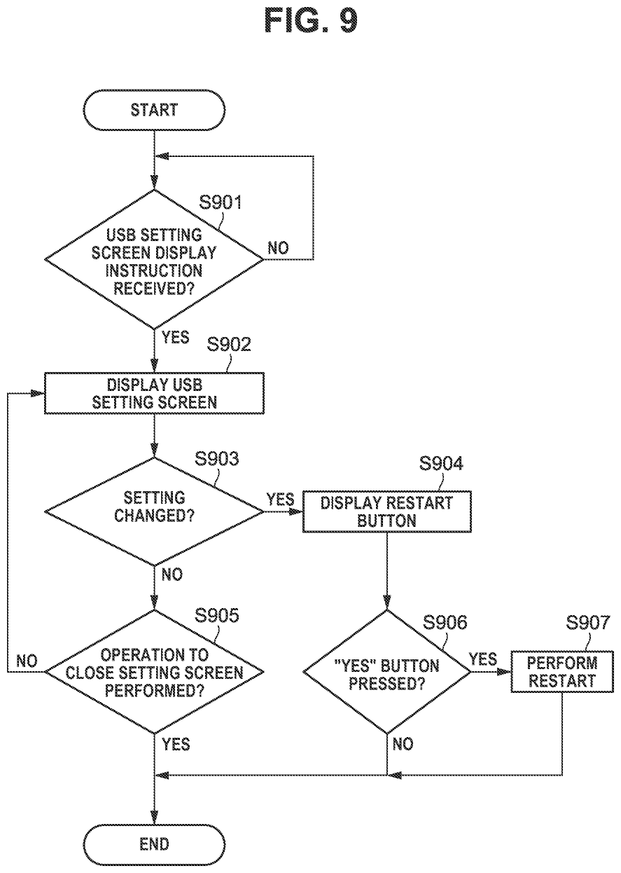

FIG. 9 is a flowchart illustrating a flow of processing performed when a user changes the USB setting.

In step S901, the CPU 101 determines whether a USB setting screen display instruction to display the screen 301 is received based on a user operation. In a case where the USB setting screen display instruction is not received (NO in step S901), the processing returns to step S901 and the CPU 101 waits for the USB setting screen display instruction. In a case where a USB setting screen display instruction is received (YES in step S901), the processing proceeds to step S902.

In step S902, the CPU 101 displays the screen 301. In step S903, the CPU 101 determines whether a change of the setting is received via the screen 301. In a case where a change of the setting is received (YES in step S903), the processing proceeds to step S904.

In step S904, the CPU 101 displays the screen 801 illustrated in FIG. 8 to prompt a restart of the image forming apparatus 1. In step S906, the CPU 101 determines whether the “YES” button 802 on the screen 801 for prompting a restart of the image forming apparatus 1 is pressed. In a case where the press of the “YES” button 802 is detected (YES in step S906), the processing proceeds to step S907. In step S907, a restart of the image forming apparatus 1 is performed. In step S906, in a case where the press of the “NO” button 803 is detected (NO in step S906), the CPU 101 closes the screen 301, and the processing ends.

In step S903, in a case where the setting is not changed (NO in step S903), the processing proceeds to step S905. In step S905, the CPU 101 closes the screen 301 when operation to close the screen 301 is performed, and the processing ends.

By performing the above-described processing, it is possible to normally use the functions of the information processing apparatus while restricting the use of externally connected USB devices optionally used by a user depending on the setting values, by allowing the USB devices used for the functions of the apparatus to be used.

### Other Exemplary Embodiments

The various examples and exemplary embodiments are described above, but the scope and the range of the present disclosure are not limited to the specific descriptions in the present disclosure.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-005655, filed Jan. 18, 2023, which is hereby incorporated by reference herein in its entirety.

What is claimed is:

1. An information processing apparatus comprising:
a first controller configured to detect at least a first type storage device that is universal serial bus (USB)-connected to the information processing apparatus externally and is connectable by a user, and a second type storage device that is USB-connected to the information processing apparatus inside the information processing apparatus; and
a second controller configured to associate a storage device detected by the first controller with a driver,
wherein in a case where setting values relating to storage devices do not satisfy a predetermined condition, the second controller performs control in a first mode in which respective drivers to be associated with the first type storage device and the second type storage device are each set to be a storage driver, and
wherein in a case where the setting values satisfy the predetermined condition, the second controller performs control in a second mode in which the driver to be associated with the second type storage device is set to be the storage driver and the driver to be associated with the first type storage device is not set to be the storage driver.

2. The information processing apparatus according to claim 1, wherein the setting values include at least a setting value of a first setting to determine whether to use the first controller and a setting value of a second setting to determine whether to use a USB-connected storage device.

3. The information processing apparatus according to claim 2, wherein the predetermined condition is a condition in which at least one of the setting values of the first setting and the second setting is OFF.

4. The information processing apparatus according to claim 3, wherein in the case where at least one of the setting values of the first setting and the second setting is OFF, a driver is not associated with the first type storage device.

5. The information processing apparatus according to claim 3, wherein the setting values include a setting value of a third setting to determine whether to associate a general-purpose driver different from the storage driver with a USB-connected storage device.

6. The information processing apparatus according to claim 5, wherein the predetermined condition is a condition in which all the setting values of the first setting, the second setting, and the third setting are ON.

7. The information processing apparatus according to claim 6, wherein in the case where all the setting values of the first setting, the second setting, and the third setting are ON, the general-purpose driver is associated with the first type storage device.

8. The information processing apparatus according to claim 5, wherein in a case where the setting values of the first setting and the second setting are ON, and the setting value of the third setting is OFF, the setting values do not satisfy the predetermined condition.

9. The information processing apparatus according to claim 1,
wherein the first controller acquires device information including a Vendor identifier (ID), a Product ID, and a Class ID from the detected storage device, and
wherein the second controller associates the storage device with a driver based on the acquired device information in the first mode or the second mode.

10. The information processing apparatus according to claim 1, wherein the second controller enables data to be stored in the second type storage device to be encrypted and mounts the second type storage device as a system use area, after associating the second type storage device with the storage driver.

11. The information processing apparatus according to claim 1, further comprising a user interface configured to receive an instruction from a user,
wherein the setting values are received via a screen displayed by the user interface.

12. The information processing apparatus according to claim 1, wherein the first type storage device is a USB memory, and the second type storage device is a solid state device (SSD).

13. The information processing apparatus according to claim 1, wherein the storage driver is a driver that enables data to be read from and written into a storage device including a storage area.

14. A control method for an information processing apparatus, the control method comprising:
receiving setting values relating to storage devices;
detecting at least a first type storage device that is universal serial bus (USB)-connected to the information processing apparatus externally and is connectable by a user, and a second type storage device that is USB-connected to the information processing apparatus inside the information processing apparatus;
associating, if the setting values do not satisfy a predetermined condition, a detected storage device with a storage driver in a case where the detected storage device is the first type storage device or the second type storage device; and
not associating, if the setting values satisfy the predetermined condition, the detected storage device with the storage driver in a case where the detected storage device is the first type storage device and associating the detected storage device with the storage driver in a case where the detected storage device is the second type storage device.
